(19) United States
(12) Patent Application Publication
(10) Pub. No.: US 2009/0106681 A1
(43) Pub. Date: Apr. 23, 2009

(54) METHOD AND APPARATUS FOR GEOGRAPHIC SPECIFIC SEARCH RESULTS INCLUDING A MAP-BASED DISPLAY

(76) Inventors: Abhinav Gupta, Sunnyvale, CA (US); Timothy Tully, San Jose, CA (US); Jiangyi Pan, Fremont, CA (US); Wei Du, Burbank, CA (US); Joydeep Sen Sarma, Sunnyvale, CA (US); Shyam Kapur, Sunnyvale, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(21) Appl. No.: 11/875,040

(22) Filed: Oct. 19, 2007

(51) Int. Cl. G06F 3/048

(52) U.S. Cl. 715/771

(57) ABSTRACT

A method and apparatus for geographic specific search results in response to a search request having an address field includes retrieving map portion having the address thereon. The method and system further includes determining entities in geographic relation to the address and generating an entity listing, where the entity listing includes listing of the various entities. These entities may represent any type of business, club, library, government building/office, or other locations. The method and apparatus further includes determining various descriptive terms that relate to the entities which are in geographic relation to the address. These terms include hyperlinks to corresponding entity listings. The method and apparatus further includes generating a visual display that includes: the map portion with the address displayed thereon; an entity portion that includes the entity listing; and a term portion with a taxonomical display of the plurality of terms.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to electronic search engines and electronic maps. More specifically, embodiments of the present invention are directed towards geographic search results including geographic related information associated therewith.

### BACKGROUND OF THE INVENTION

Interactive computing systems have greatly enhanced the ability for users to access geographic information using maps. Early techniques included the general electronic display of maps themselves. Advancements included interactive features using the mapping technology, such as driving directions with visual overlay on the maps themselves.

There currently exist numerous electronic map engines with various levels of functionality. For example, Internet-based search engines now offer the ability to map a particular location by entering the address in a search request field. The search engine may then denote the geographic location on the map with a visual indicator, such as an arrow or a balloon linked to the point on the map.

Some engines also offer the ability to change the underlying map, such as presenting a map-based view, a satellite view or a combination of the two. There is also the emergence of software operations referred to as “mash-ups” that combine mapping engines with additional information to provide a map-based display with the additional information in an overlay. A common example may be the display of real estate information, e.g. estimated housing prices, overlaid on a map to indicate the location of the various properties.

Different engines can also provide related information, such as traffic-related information or the location of particular establishments. For example, a map may include an overlay of all the nearest locations of a designated coffee-house chain or hotels of a particular hotel chain.

Although, the existing mapping engines are limited in the amount and type of information presented to a user. Mapping engines make limited use of search engine technology and have limited associated advertising, as well as limited relevant hyperlinks. Searching techniques are capable of recognizing geographical information associated with the search, such as for example the name of the city, and can then customize advertising relative to this information. Common exemplary advertisements may include an advertisement for a local restaurant or an airline offering air fare to the city. These advertisements tend to be static, providing limited usefulness for the searcher because the generated ads are determined by the search engine and may be entirely irrelevant to the user's purpose for using the mapping engine.

### SUMMARY OF THE INVENTION

Generally, a method and apparatus for geographic specific search results in response to a search request having an address field includes retrieving map portion having the address thereon. The map portion may be retrieved from one or more databases of map information with an address position indicator overlaid thereon. The method and system further includes determining entities in geographic relation to the address and generating an entity listing, where the entity listing includes listing of the various entities. These entities may represent any type of business, club, library, government building/office, or other locations. The entities may also be internet-based in nature, such as for example an online vendor.

The method and apparatus further includes determining various descriptive terms that relate to the entities which are in geographic relation to the address. These terms include hyperlinks to corresponding entity listings, for example a term may be for “automotive,” which links to the listing of geographically relevant automotive-type entities.

The method and apparatus further includes generating a visual display that includes: the map portion with the address displayed thereon; an entity portion that includes the entity listing; and a term portion with a taxonomical display of the plurality of terms. This generated visual display may be in the form of encoding as well as graphics sent to a user that requested the search. Thereby, the method and apparatus provides geographic specific information, which in further embodiments includes additional interactivity through correlation of the taxonomical display of the terms and the terms relating to entity listings.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of one embodiment of a processing system that includes an apparatus for geographic specific search results;

FIG. 2 illustrates a block diagram of one embodiment of an apparatus for geographic specific search results;

FIG. 3 illustrates a flowchart of the steps of one embodiment of a method for geographic specific search results;

FIG. 4 illustrates a sample screen shot of one embodiment of a visual display in response to geographic specific search results; and

FIG. 5 illustrates a block diagram of one embodiment of a method for geographic specific search results.

### DETAILED DESCRIPTION OF THE INVENTION

In the following description of the embodiments of the invention, reference is made to the accompanying drawings that form a part hereof, and in which is shown by way of illustration exemplary embodiments in which the invention may be practiced. It is to be understood that other embodiments may be utilized and structural changes may be made without departing from the scope of the present invention.

FIG. 1 illustrates one embodiment of a system 100 that provides for geographic specific search results. The system 100 includes a processing device 102, a map database 104, and an entity database 106. A user 108 can access the processing device 102 via the Internet 110 using a local computing device 112.

The processing device 102 may be one or more processing elements in either a local or distributed computing environment. The processing device 102 may perform processing operations, as described in further detail below, in response to executable instructions received from one or more storage devices and/or storage media. The map database 104 and the entity database 106 may be one or more storage devices operative to store map data and entity data, respectively, therein. The memory devices 104 and 106 may include one or more memory storage devices in a localized or distributed storage environment. It is also recognized that the Internet 110 is not specifically restricted to the publicly available Internet 110, but more generally may be any suitable type of communication network.

The map data stored in the map database 104 may be one or more types of maps for any number of locations, such as predefined maps of various sizes. The maps may also be dynamically generated based on underlying map data. In one embodiment, the map data used for the underlying map may be in accordance with known map display techniques, wherein the processing device 102, as described in further detail below, is operative to provide additional overlay information thereon.

The entity data stored in the entity database 106 includes information associated with various entities. As noted above, the entities may represent any type of business, club, library, government building/office, or other locations, whether physical or internet-based locations. More generally, the entities relate to any person or place of interest that can be associated with the map and subsequent address on a map search. The entity data may include descriptive data, e.g. meta data, associated therewith. For example, an exemplary entity may be a restaurant, where the entity data can include the name, address, type of cuisine, price range, quality rating, or any other related information. The entity information may also relate to sponsored information, such as advertisements or the inclusion of links or other information in a sponsored fashion. One embodiment includes the entities being informational for a user, whereupon the presentation of the information may be used for revenue generation techniques, such referring a new customer to a business based on the business being listed as an entity.

In the system 100, the user 108 presents a search request to the processing device 102 through the user's computer 112 and via the internet 110. It is recognized that various elements relating to cross-communication techniques and protocols are omitted herein for clarity purposes only and communication techniques may be in accordance with any known or otherwise suitable techniques.

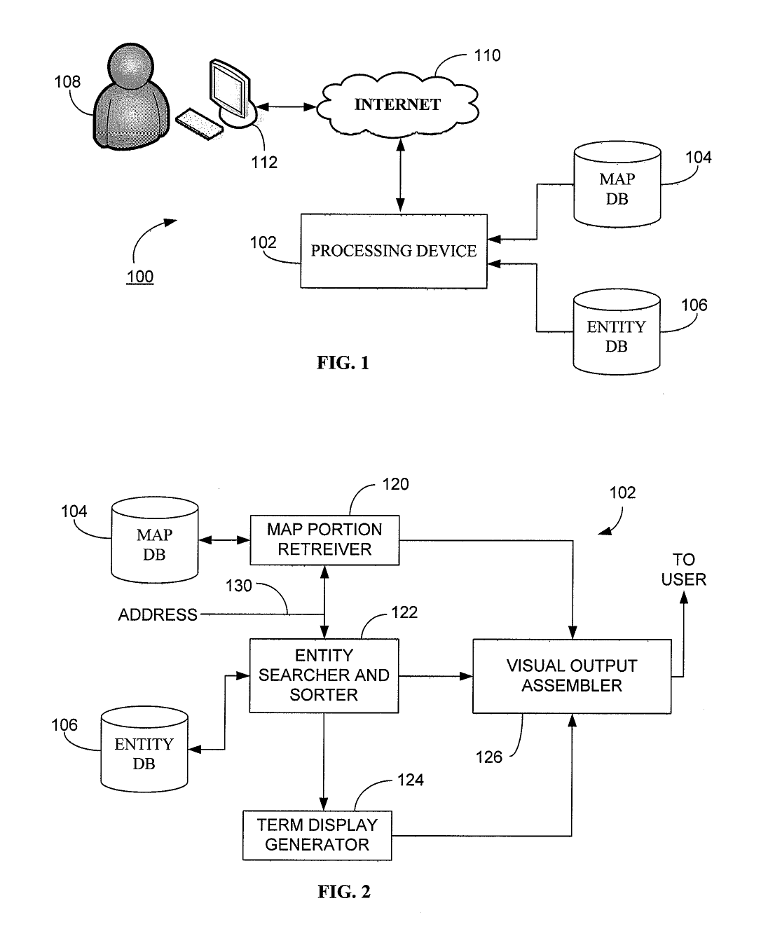

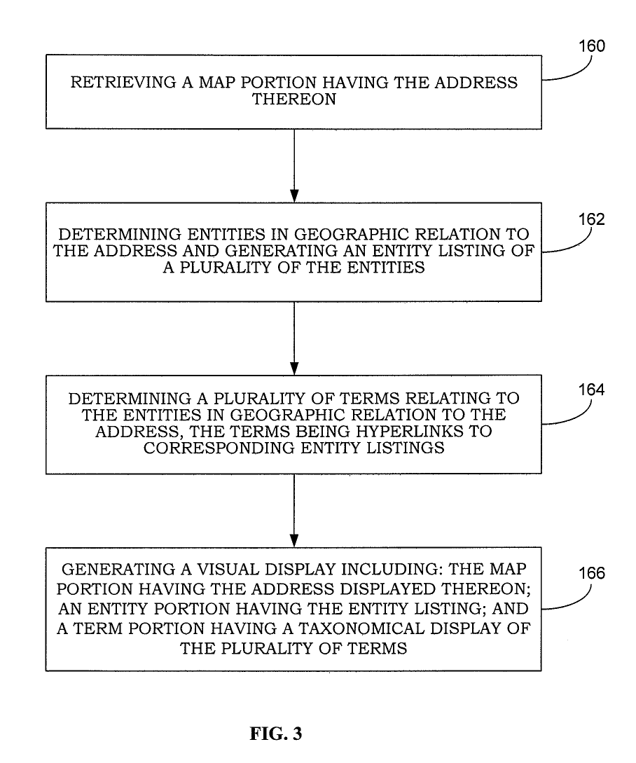

The processing device 102, through the operation of various processing operations, as described in greater detail below with respect to FIGS. 2 and 3, receives the search request and is operative to generate a visual display including at least three separate portions, a map portion that has the address information overlaid on a map display, a entity portion that includes a list of entities and a term portion having a taxonomical display.

In response to the search request, the processing device 102 retrieves map information from the map database 104. The processing device 102 may also retrieve entity information from the entity database 106, such as information based on the address received in the search request. As described in further detail below, additional information may also be retrieved to compliment information retrieval from the search request.

Using the entity information, the processing device thereupon determines a plurality of terms that relate to the entities. For example, one technique may be to extract all the various terms from the entity descriptions, calculate the frequency of various terms and then display the most common terms. Another technique may be to generate a taxonomical display, such as a term cloud whereby the font aspects of various terms visually illustrate importance or ranking.

The processing device 102 thereupon assembles these portions and generates the visual output display. The display may be encoded text with additional graphics or links to graphics readable by the user computer 112. The output display includes the map portion, entity portion and the term portion as described above.

The processing device 102 may also receive additional input as the visual output display can be interactive in nature. For example, a user may select one of the terms in the term portion, whereupon the entity portion can be accordingly updated. This operation can be integrated between one or more local applications on the user computer 112, can be facilitated based on computing operations performed in the processing device, or can be a combination of both local (i.e. computer 112) and remote (i.e. processing device 102) processing operations.

In another interactive example, the user may select a different portion of the map, such as clicking a mouse or other cursor element on a different portion of the map. This clicking action may re-center the map, and hence update not only the term portion but also the entity portion. These portions may be updated in a similar fashion to the above-described operations for generating the original term portion and entity portion of the previous display. Additionally, the map portion is updated to reflect the change in map-orientation, as including address overlays where applicable. For example, if the user selects a location 4 blocks to the East, the map may re-orientate to center the new location, as well as update the entity and term portions to reflect information relative to this new center location.

In another embodiment, the processing device 102 may add the additional information to compliment the visual search results. One technique may be determining additional information that relates to the visual search. For example, a search may including search the address of a bookstore. The additional information provided with the visual output may include information relating to the bookstore itself, such as bookstore advertisements, user generated content (e.g. reviews) of the bookstore, competing or nearby bookstores, existing online or Internet-based bookstore websites that may have an existing contractual or business relationship with the search engine, as well as any other suitable types of information.

FIG. 2 illustrates one embodiment of the processing device 102 in communication with the map database 104 and the entity database 106. In this embodiment, the processing device 102 includes a map portion receiver 120, an entity searcher and sorter 122, a term display generator 124 and a visual output assembler 126. It is recognized that these elements 120, 122, 124 and 126 may be one or more processing elements performing defined functions or in another embodiment may be representative of one or more processing elements performing operations in response to executable instructions, such as instructions received from one or more storage media. It is also recognized that additional elements usable for processing and communication operations, in accordance with known techniques, have been omitted for clarity-purposes only.

In one embodiment, the map portion retriever 120 and the entity searcher and sorter 122 may receive an address field 130. This address field 130 may be received from a search request from the user 108 of FIG. 1, or in another embodiment, may be received based on a user updating a map, such as selecting a new geographic location.

The map portion retriever 120, having this address information, is operative to retrieve a corresponding map from the map database 104, where the map reflects the geographical illustration of the location, such as for example on a standard map, on a terrestrial map composed of satellite-based photographs, or a hybrid combination of these maps. It is also recognized that the map portion retriever 120, where applicable, may include one or more engines for generating the map portion where the map database data includes parameters or information for generating a map instead of providing a static graphical map display.

The entity searcher and sorter 122 is also operative to receive the address 130. This element 122 accesses the entity database 106 based on the address information, for example determining all entities within a predefined geographic range of the address. It is also recognized that the entity database 106 may include additional entity information, such as sponsored information for a pre-existing sponsor relationship, whereby sponsorship information can relate to the address information. By way of example, regardless of the entity information, a particular hotel chain may seek to include entity information such as the location and distance to the nearest hotels.

The searcher and sorter 122 searches for the entity information from the entity database 106 and then sorts this information. As described above, the sorting may be performed using the description or meta data associated with the terms. By way of example, the element 122 may determine the total number of entities having common terms and generate corresponding associations. Using the above-listed example of restaurants, the element 122 may assemble a list of all entities having a restaurant descriptor. The element 122 may assemble another list of all entries of restaurants having a descriptor of a particular ethnicity, such as Chinese food. It is recognized that many entities may appear on various different lists.

The element 122 may thereupon provide the lists of entities and corresponding terms to the term display generator 124. The generator 124 may then generate the taxonomical term display of the various terms, where the terms relate to the descriptions of the entities. The display generator 124 may thereupon provide a display, or encoding that can be processed to generate the display, to the visual output assembler 126.

As illustrated in FIG. 2, the map portion retriever 120 and the entity search and sorter 122 are both also coupled to the visual output assembler 126. The map portion retriever 120 may provide the map portion, or executable encoding that can be processed to generate the map portion, to the assembler 126. Similarly, the element 122 may provide the entity lists to the assembler 126, where the entities of the entity list may include hyperlinks to active web locations, business listing elements, business referral web page or other mechanism, or any other type of associated information to facilitate presentation of pertinent information to the user.

It is recognized that the entity lists may include instructions for the assembling and ordering of the lists. The sequence of the ordering of the entities in the list may be governed by any number of possible techniques, such as using a sequence of order operations, including financial or commercial relationships, distance to/from address, business listings, customer ratings, etc. The entity information may include the full set of entities and ranking or sequencing information, for each of the different possible entity listings as defined by corresponding terms.

It is also recognized that there may be different sequence or listing of entities based on the timing of the generation of the geographic display. For example, an initial entity display may be defined by a commercial relationship and not tied to any specific term, whereas additional entity listings, as based on term selections (as described in further detail below), can then be based on different factors.

Thereupon, the visual output assembler 126 can assemble the final output display based on the map portion, the entity portion and the term portion. This assembled output display can be provide to the user 108 (of FIG. 1) using known transmission techniques.

FIG. 3 illustrates the steps of one embodiment of a method for geographic specific search results in response to a search request including an address. The method begins, step 160, by retrieving a map portion having an address thereon. The address is received in a search request, typically from a user, such as user 108 of FIG. 1. The search request may be received through a search request page, such as a map page allowing for a user to enter an address or other type of landmark information, e.g. Grand Central Station, into the search bar.

The next step, step 162, is determining entities in geographic relation to the address and generating an entity listing of a plurality of entities. For example, as described above, the entity searcher and sorting device 122 may access entity information from the entity database 106, including searching the entity database based on the address and finding entities within a defined geographic distance, such as for example within a five mile radius. The generation of the entity listing may include generating a general listing and also customizing the listings based on associated commonalities, for example generating a separate listing of all restaurants, a separate list of all gas stations and convenience stores, a separate listing of all hotels, etc.

In this embodiment, the next step, step 164, is determining a plurality of terms relating to the entities in geographic relationship to the address, where the terms may be hyperlinks to entity listings. As described above, the term determination may include sorting and filtering terms associated with different entities to provide a taxonomical interface. The determination of the terms may be performed in the sorter 122 and/or the term display generator 124 of FIG. 2.

In this embodiment, the next step, step 166, includes generating a visual display that can be provided to a user who presented the original search request. This visual display includes the map portion with the display of the address, an entity portion that includes at least a partial list of entities and a term portion that includes the taxonomical display of the plurality of terms. Thereby, the user can be presented with an output display of a geographic specific search results that includes the visual display of the address on a map, the geographic relevant entity information and an interactive taxonomical term display relating to the entity information.

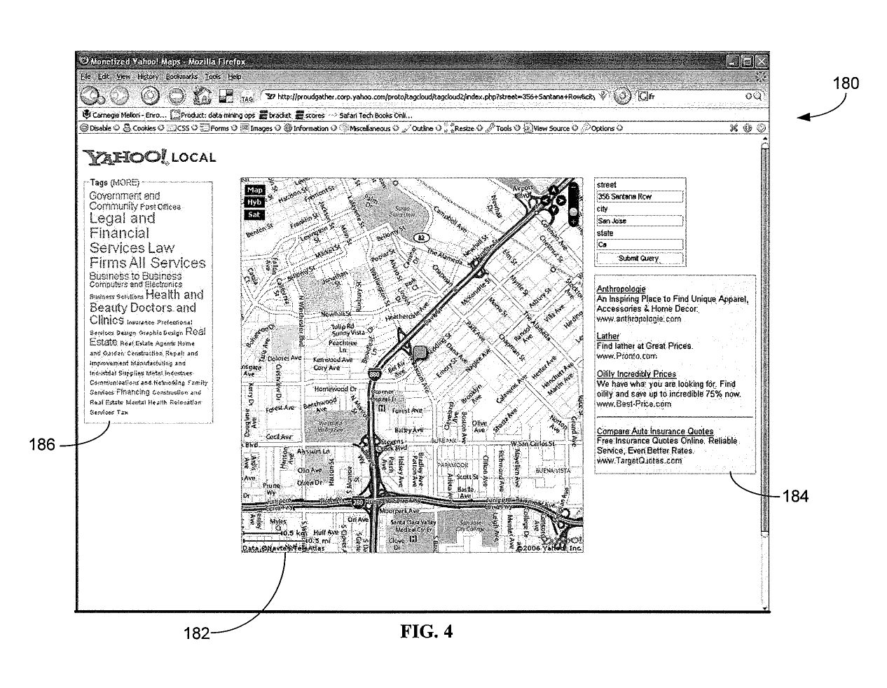

FIG. 4 illustrates a sample output display 180 for a geographic search result. This display 180 includes a map portion 182, a entity portion 184 and a term portion 186.

The map portion 182 includes a balloon overlay to indicate the address of the search result, which is also visually indicated as being the center of the map. This sample display map portion 182 includes user selections for different types of maps, such the displayed map, a satellite map and a hybrid map combining map and satellite features. Also visible in the upper left hand corner of the map portion 182, navigation arrows allow for user interaction with the map and a scroll bar to facilitate zooming in on the map or alternatively to scope out.

The entity portion 184 includes a listing of entities, which may include advertising that can be relevant to the address location. As described above, these entity listings may be active hyperlinks to other web locations or can be to techniques for providing contact information such as a business listings page or a business-referral page, for example.

The term portion 186 is a taxonomical display that in this embodiment includes the list of relevant terms, where the relevance of the terms are illustrated based on variances in the display fonts. As described in further detail below, the terms in the term portion 186 are active links to corresponding entity lists, whereby selection of a term thereby provides for operations to update the entity list, listing entities germane to the selected term.

Moreover, as also described below, the display 180 is updatable based changes to the map portion, whereby if a user selects a new address, by entering a new search term or clicking on a geographic location on the map, not only is the map portion 182 updated to reflect this change, the term portion 186 and the entity portion 184 are also updated because the change in address changes the entities of the entity lists and the corresponding terms in the taxonomical display.

In one embodiment, the present technique may be usable with or incorporate tracking information regarding user activity or behavior. For example, if the user is logged in to the search system or otherwise recognized by the search system, the search system may record the user's search request and corresponding activities using the visual search results. This acquired information may be used to further customize the search engine not only relative to the specific user, but also relative to a large set of users. For example, it may be determined that a particular address has been searched X number of times, and therefore it may be beneficial to have related or corresponding advertisement or other information readily available for subsequent searches and subsequent targeted advertisements for the user(s).

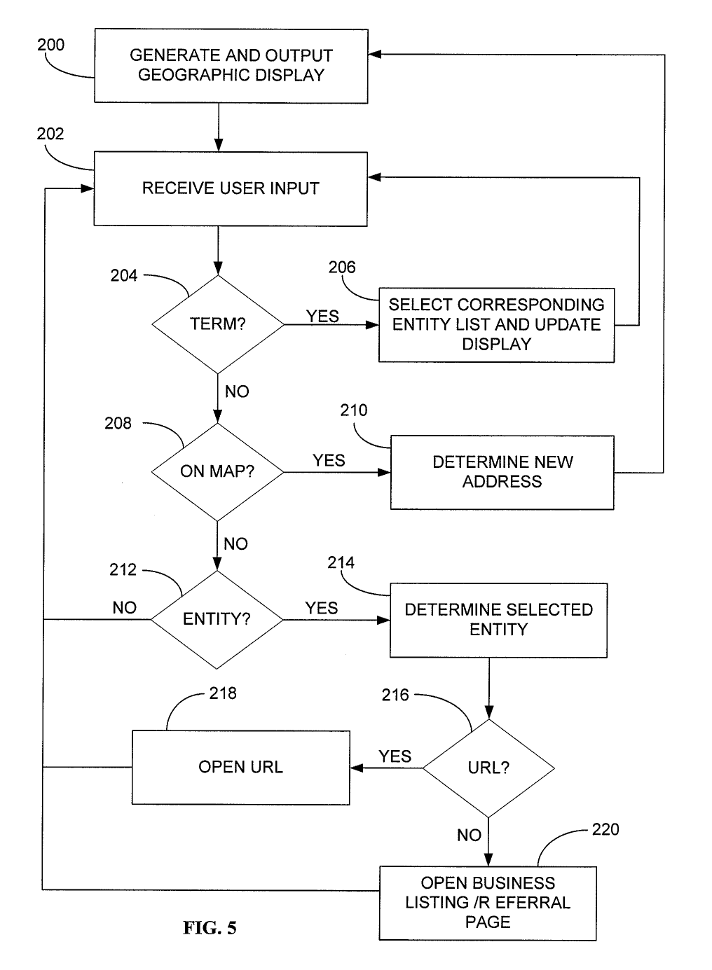

FIG. 5 illustrates a flowchart of one embodiment of geographic visual search results display including additional interactivity beyond the initial presentation. This functionality may be performed by processing components in response to executable instructions and can be performed local to the display device or remote, such as through one or more networked processing operations, for example on a server that provides the map and additional information.

In this embodiment, the first step, step 200, is generating an output of a geographic display. For example, this step may be performed by the operations of the flowcharts of FIG. 3 and include the generation of the screenshot 180 of FIG. 4. The output display includes the map portion, the entity portion and the term portion. In one embodiment, an initial display may include generalized entity listings, which can include advertisement listings, based the absences of a user presenting a term-specific selection.

A next step, step 202, is to receive user input. This user input is received through interaction with the geographic visual display. In step 204, the method includes determining if the input is a term selection. This term selection may include a user selecting a particular term in the term portion. If the user input is a term selection, the method proceeds to step 206, selecting the corresponding entity list and the update the display of the entity portion accordingly. Whereby, the method then revert back to step 202 to await another user input.

In the event the decision at step 204 is in the negative, a next step, step 208, is to determine if the user input is on the map portion. If yes, the method includes determining the new address, step 210. This may be performed by determining the user selection location and based on that relative to the displayed map, calculating or otherwise estimating the address of the selected position. Upon this determination, the method thereby may revert back to step 200 which includes the generation and output of the geographic display, this time with the various portions updated to reflect the new address.

In the event the decision at step 208 is in the negative, a next step, step 212 is to determine if the user input is an entity selection. This entity selection may include the user clicking on active hyperlink elements of the entity listing in the entity portion. In this embodiment, if the user input is not from the entity, the method may revert back again to step 202 to await a further user input.

If the user selection is an entity selection, a next step, step 214, is to determine which entity has been selected. In step 216, a determination is made if the selected entity includes a URL or other type of specified link, such as a redirection page used for tracking internet traffic for example. If the entity does include a URL, the next step, step 218, includes opening the corresponding URL for the user.

If the entity does not include a URL, a next step, step 220, may include opening a business listing or a referral page. A business listing may be a predefined listing database that includes business contact information. A referral page may be an online form or other type of interactive feature whereby a user can enter information and then be contacted by the business, such as a lead generation operation. Systems and methods for lead generation are described in commonly-owned U.S. patent application Ser. No. 11/756,947, entitled “TRUSTED PRIVACY INFORMATION MANAGEMENT,” filed on Jun. 1, 2007 with attorney docket no. 12729-273 and U.S. patent application Ser. No. 11/745,263, entitled “TRUSTED THIRD PARTY CLEARING HOUSE FOR LEAD TRACKING,” filed on May 7, 2007 with attorney document no. 12729-272, the disclosures of which are hereby incorporated by reference herein in their entirety. Thereby, after steps 218 and 220, the method may again revert back to step 202 to await further user input.

As such, the method and apparatus provides for the geographic specific search results in response to a search request that includes an address. The search results includes geographic specific information, as well as interactive features to update or otherwise customize the geographic specific information for the user. Moreover, this is all provided in a visually interactive format based on the map display in conjunction with the taxonomical term display and the entity listing for ease of use for the user.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms memory and/or storage device may be used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for geographic specific search results in response to a search request including an address, the method comprising:
retrieving a map portion having the address thereon;
determining entities in geographic relation to the address and generating an entity listing of a plurality of the entities;
determining a plurality of terms relating to the entities in geographic relation to the address, the terms being hyperlinks to corresponding entity listings; and
generating a visual display including: the map portion having the address displayed thereon; an entity portion having the entity listing; and a term portion having a taxonomical display of the plurality of terms.

2. The method of claim 1 further comprising:
determining if the address directly corresponds with an entity address; and
if the address does correspond with an address: generating a hyperlink to a lead generation page for the entity; and including the hyperlink in the visual display.

3. The method of claim 1 further comprising:
referencing an advertisement database based on the entities in geographic relation to the address to determine advertising relationships; and
ordering the listing of entities in the entity portion based on the advertising relationships.

4. The method of claim 1 further comprising:
receiving a position adjustment request to an updated position;
updating the visual display including: a map portion having the updated position displayed thereon; an updated entity portion having an updated listing of entities in geographic relation to the updated position; and an updated term portion having the taxonomical display of a plurality of updated terms relating to entities in geographic relation to the updated position.

5. The method of claim 1 further comprising:
ordering the listing of entities in the entity portion based on a distance factor for each listing, the distance factor representing a distance between the address and an address for the entity.

6. The method of claim 1 further comprising:
receiving entity selection input command based on the user-selection of a hyperlink associated with one of the entities listed in the entity portion; and
providing a display relating to the entity.

7. The method of claim 6, wherein the displaying relating to the entity includes a web page.

8. The method of claim 6, wherein the displaying relating to the entity includes a lead generation page.

9. The method of claim 1 further comprising:
receiving a term selection input command based on the user-selection of a hyperlink associated with one of the terms listed in the term portion; and
updating the entity portion to include entities sorted based on the term.

10. The method of claim 1, wherein the map portion of the visual display includes a plurality of position indicators for each of the locations of the entities in the entity listing.

11. Computer readable media storing program code that when executed by a processor causes execution of a method for geographic specific search results in response to a search request including an address, the computer readable media comprising:
program code for retrieving a map portion having the address thereon;
program code for determining entities in geographic relation to the address and generating an entity listing of a plurality of the entities;
program code for determining a plurality of terms relating to the entities in geographic relation to the address, the terms being hyperlinks to corresponding entity listings; and
program code for generating a visual display including: the map portion having the address displayed thereon; an entity portion having the entity listing; and a term portion having a taxonomical display of the plurality of terms.

12. The computer readable media of claim 11 further comprising:
program code for determining if the address directly corresponds with an entity address; and
if the address does correspond with an address, program code for generating a hyperlink to a lead generation page for the entity; and
program code for including the hyperlink in the visual display.

13. The computer readable media of claim 11 further comprising:
program code for referencing an advertisement database based on the entities in geographic relation to the address to determine advertising relationships; and
program code for ordering the listing of entities in the entity portion based on the advertising relationships.

14. The computer readable media of claim 11 further comprising:
program code for receiving a position adjustment request to an updated position;
program code for updating the visual display including: a map portion having the updated position displayed thereon; an updated entity portion having an updated listing of entities in geographic relation to the updated position; and an updated term portion having the taxonomical display of a plurality of updated terms relating to entities in geographic relation to the updated position.

15. The computer readable media of claim 11 further comprising:
program code for ordering the listing of entities in the entity portion based on a distance factor for each listing, the distance factor representing a distance between the address and an address for the entity.

16. The computer readable media of claim 11 further comprising:
program code for receiving entity selection input command based on the user-selection of a hyperlink associated with one of the entities listed in the entity portion; and
program code for providing a display relating to the entity.

17. The computer readable media of claim 16, wherein the program code for displaying relating to the entity includes program code for displaying a web page.

18. The computer readable media of claim 16, wherein the program code for displaying relating to the entity includes program code for displaying a lead generation page.

19. The computer readable media of claim 11 further comprising:
program code for receiving a term selection input command based on the user-selection of a hyperlink associated with one of the terms listed in the term portion; and
program code for updating the entity portion to include entities sorted based on the term.

20. The computer readable media of claim 11, wherein the map portion of the visual display includes a plurality of position indicators for each of the locations of the entities in the entity listing.
